(19) United States
(12) Patent Application Publication
(10) Pub. No.: US 2010/0127438 A1
(43) Pub. Date: May 27, 2010

(54) PLUNGER PISTON

(76) Inventors: Martin Eise, Schotten (DE); Horst Stedron, Herborn (DE)

Correspondence Address: PAULEY PETERSEN & ERICKSON, 2800 WEST HIGGINS ROAD, SUITE 365, HOFFMAN ESTATES, IL, 60169, US

(21) Appl. No.: 12/452,885

(22) PCT Filed: Jul. 24, 2008
(86) PCT No.: PCT/EP2008/006083

§ 371 Date: Jan. 27, 2010

(30) Foreign Application Priority Data
Jul. 27, 2007 (DE) 102007035640.6

(51) Int. Cl. F16F 9/05

(52) U.S. Cl. 267/124

(57) ABSTRACT

A plunger piston for an air spring. The plunger piston is designed as a hollow body and has a base to which an encircling casing part is indirectly or directly coupled. The plunger piston has, at its cover region which faces away from the base, a connecting edge for a bellows and at least one air passage opening. In order to produce this type of a plunger piston in a simple manner with little structural expenditure, the hollow body of this invention has a pot-shaped lower part which forms the base and the casing part. An upper part is placed onto the lower part and is connected to the lower part in an air-tight fashion, and the upper part has the connecting edge.

### BACKGROUND OF THE INVENTION

1. Field of the Invention

This invention relates to a plunger piston for an air spring, which plunger piston is formed as a hollow body and has a bottom to which a circumferential casing part is indirectly or directly coupled, and a plunger piston, in its cover region remote from a bottom, has a connecting edge for a bellows and at least one air passage opening.

2. Discussion of Related Art

A plunger piston of this kind is known from U.S. Pat. No. 6,386,524 B1, wherein a hollow body is formed by two circumferential walls. An inner circumferential wall is situated concentric to an outer circumferential wall. The two circumferential walls are supported in relation to each other by reinforcing ribs. The inner circumferential wall encompasses an air passage opening in the cover region of the plunger piston. The air passage opening is delimited by an edge to which a bellows can be fastened. The bottom region of the plunger piston can be sealed by a plate. The plate in this case is integrally joined, for example glued, to the lower edges of the circumferential wall. In order to provide the air spring with the greatest possible air volume, the inner circumferential wall has air passage openings that connect the individual volume regions of the hollow body to one another. When rapid load changes occur, undesirable air oscillations can occur in the region of these air passage openings. In addition, the inner circumference wall takes up space and thus limits the available air volume of the hollow body.

### SUMMARY OF THE INVENTION

One object of this invention is to provide a plunger piston of the type mentioned above but which has a simple design and is easy to produce.

This object is achieved with a hollow body that has a cup-shaped lower part comprised of the bottom and the casing part. An upper part is placed onto the lower part and connected to the lower part in an airtight fashion, and the upper part has the connecting edge.

The cup-shaped lower part can be easily produced and forms the lower airtight closure of the hollow body. The upper part can be placed like a cover onto the lower part, thus delimiting the cavity defined by the hollow body. The upper part with its connecting edge forms the coupling point for the bellows. It is thus possible to control the introduction of force from the upper part to the lower part by the embodiment of the upper part. In particular, a load transfer can be carried out, if so desired, from the upper part directly into the circumferential casing part of the lower part. This permits a simpler and more stable design of the plunger piston.

According to one embodiment of this invention, it is possible for the casing part to have a cylindrical region that transitions into a circumferential, cylindrical side wall of the upper part having the same diameter. The cylindrical regions of the upper part and lower part that transition into each other can form the contact and rolling surface for the bellows. This embodiment also permits a kit-like design of the plunger piston. For example the upper part, embodied in the form of a universally usable component, can be placed onto various lower parts. Thus, it is possible for the various lower parts to enclose various air volumes.

The kit-like embodiment of the plunger piston can also be achieved within the scope of this invention if a standardized interface is provided between the lower part and the upper part.

An airtight connection of the lower part to the upper part can be achieved in a simple fashion if the lower part and the upper part each has a circumferential edge and the upper part with the lower part are joined to each other at the edges by a sealed connection.

In order to improve the load transfer, according to one embodiment of this invention, the lower part and/or the upper part each is reinforced by reinforcing elements. In this case, the reinforcing elements of the lower part can be embodied in the form of ribs that are formed integrally onto the casing part and extend in the radial direction.

The design of the upper part achieves a more stable structure because the reinforcing elements of the upper part are formed integrally onto the connecting edge and protrude into the air passage region enclosed by the connecting edge and because at least part of the reinforcing elements, in their region remote from the connecting edge, are connected to a reinforcing part. This design makes it possible to reliably absorb and transfer radially acting clamping forces of the bellows.

A further reinforcing of the plunger piston is achieved if at least part of the reinforcing elements of the cover part have a supporting part that is supported against a counterpart supporting part of the lower part.

In one embodiment of this invention, the reinforcing elements of the lower part and upper part are at least partially supported against one another. This promotes the shunting of force from the upper part to the lower part.

In one embodiment of this invention, the cover-like upper part encloses a partial cavity that combines with the partial cavity formed by the lower part to form a whole cavity, with the partial cavities communicating in an air-conveying fashion.

The lower part and upper part are preferably embodied in the form of injection-molded plastic parts.

If the upper part has a convex, rounded transition that adjoins the cylindrical, circumferential side wall and supports a transition section, the transition section is sloped toward the lower part, and the annular connecting edge adjoins the transition section by a concave rounded transition, then a transfer region between the side wall and the connecting edge deflects the bellows in an optimized fashion in terms of tension.

According to one embodiment of this invention, the bottom of the lower part has a reinforcing element coupled to the bottom or embedded into the bottom, for example during the plastic injection-molding process. The reinforcing element stiffens the bottom at least partially. The transmission of force to a connected axle or body component is thus improved. This is accompanied by advantages with regard to the distribution of force if the bottom is not resting with its entire surface area against the axle/body component.

The reinforcing element can advantageously be formed as a plate or ring, with the plane of the plate or ring oriented in the direction of the bottom plane.

If a plunger piston is embodied so that the reinforcing element has a greater hardness than the bottom and is comprised, for example, of metal, then the lower part can be produced in a cost-optimized way in the form of a composite component made of two different materials.

### BRIEF DESCRIPTION OF THE DRAWINGS

This invention is explained in view of an exemplary embodiment shown in the drawings, wherein:

FIG. 1 is a perspective, exploded view of a plunger piston having a lower part and an upper part;

FIG. 2 is an assembled view of the plunger piston according to FIG. 1, in a sectional side view; and

FIG. 3 is perspective, sectional view of the plunger piston according to FIGS. 1 and 2.

### DETAILED DESCRIPTION OF THE INVENTION

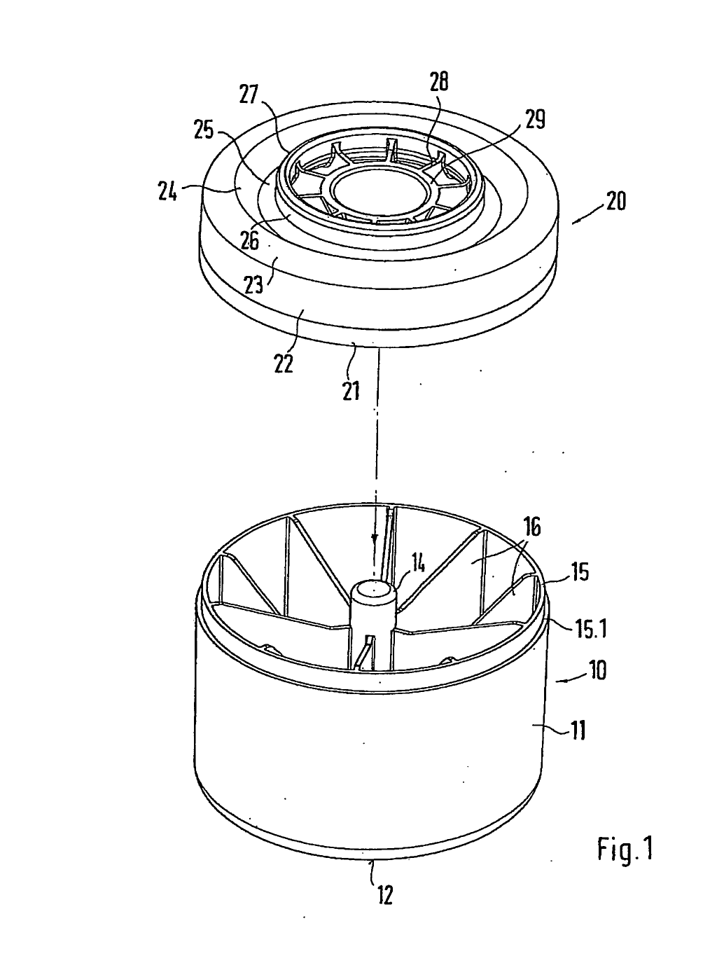

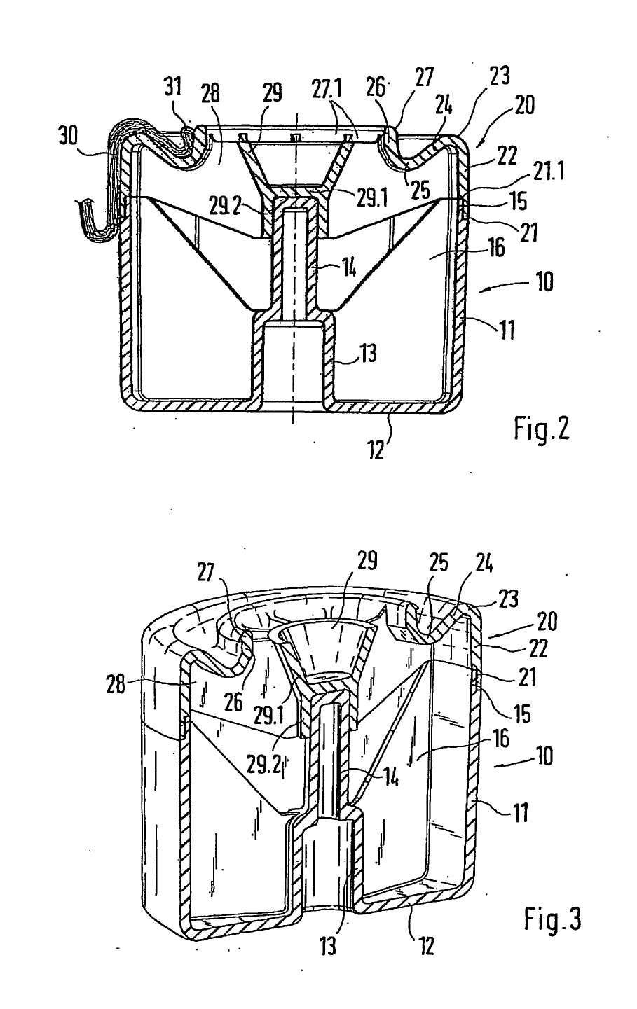

FIG. 1 shows a plunger piston comprised of a lower part 10 and an upper part 20. The structural embodiment of these two components is shown in greater detail in FIG. 2. Accordingly, the lower part 10 has a bottom 12 onto which a circumferential casing part 11 is integrally formed. A fastening receptacle 13 is also formed centrally onto the bottom 12. The fastening receptacle 13 encloses a receiving space into which a fastening element such as a nut can be inserted and the cylindrical fastening receptacle 13 transitions into a counterpart support part 14 that is centrally formed.

The counterpart support part 14 encloses a receiving region. A fastening screw that is screwed into the nut of the fastening receptacle 13 is accommodated with its thread in the counterpart support part 14.

The circumferential, cylindrical casing part 11 has a circumferential edge 15. The edge 15 is formed by a step-like cross-sectional reduction of the casing part 11.

Reinforcing elements 16 are situated in the cavity enclosed by the lower part 10. The reinforcing elements 16 are embodied in the form of ribs and extend radially inward from the casing part 11. They are integrally connected to the fastening receptacle 13, the casing part 11, and the bottom 12. As shown in FIG. 1, one part of the reinforcing elements 16 is formed only onto the fastening receptacle 13 while another part of the reinforcing elements 16 is formed onto both the fastening receptacle 13 and the counterpart support part 14. The different reinforcing elements 16 are arranged in a constantly alternating fashion. The lower part 10 is embodied in the form of an injection-molded part and is constructed without an undercut in the direction of its central longitudinal axis, the dot-and-dash line shown in FIG. 2, so that it can be demolded in this direction without requiring a slide mold.

The upper part 20 has a circumferential edge 21 and is embodied with a step-shaped shoulder like the edge 15 of the lower part 10. The edge 21 is adjoined by a cylindrical, circumferential side wall 22. The side wall transitions via a convex rounded transition 23 into a transition section 24. The transition section 24 is sloped toward the lower part 10. The transition section 24 ends in a concave rounded transition 25. The rounded transition 25 is adjoined by a connecting edge 26. The connecting edge 26 is embodied in an annular form. The connecting edge 26 ends with a bead 27 and encompasses an air passage region.

As shown in FIG. 1, reinforcing elements 28 are formed onto the connecting edge 26. The reinforcing elements 28 extend radially inward. At their end remote from the connecting edge 26, the reinforcing elements 28 are connected to an annular circumferential reinforcing part 29.1. The reinforcing elements 28 and the reinforcing part 29.1 stiffen the connecting edge 26. As shown in FIG. 2, the reinforcing elements 28 are also integrally formed onto the side wall 22, the rounded transitions 23 and 25, and the transition section 24. The reinforcing elements 28 thus extend in the radial direction. At their ends remote from the side wall 22, the reinforcing elements 28 are formed onto the reinforcing part 29. The reinforcing part 29 has a hollow, cylindrical support part 29.2. The support part 29.2 transitions via a wall element 29.1 into a conical region of the reinforcing part 29.

Like the lower part 10, the upper part 20 is embodied in the form of an injection molded part. The demolding again occurs along the central longitudinal axis, along the dot-and-dash line shown in FIG. 2. In this direction, the upper part 20 is constructed without an undercut so that it can be removed from a mold without requiring a slide element.

The reinforcing elements 28 of the upper part 20 and the reinforcing elements 16 of the lower part 10 are matched to one another in their circumferential distribution and are spaced apart from one another by the same distances. It is thus possible for the reinforcing elements 28, 16 of the upper part 20 and lower part 10 to be aligned with one another. As shown in FIGS. 2 and 3, the reinforcing elements 28 of the upper part 20 rest on the reinforcing elements 16 of the lower part 10, thus permitting a load transfer.

During assembly, the upper part 20 is placed with its edge 21 onto the edge 15 of the lower part 10. As shown in FIG. 2, the side wall 22 and the casing part 11 transition into one another without a step. The edges 15 and 21 form respective abutting surfaces 15.1 and 21.1 that rest against each other, thus achieving a definite and limited assembly movement. In the region of the edges 15 and 21, a suitable connecting technique is used that makes it possible to produce an airtight connection. For example, an integrally joined connection can be used, in particular a glued connection, a welded connection, or the like.

As also shown in FIG. 2, the support part 29.2 rests against the counterpart support part 14 when the upper part 20 and lower part 10 are in the joined state. In this case, the support part 29.2 surrounds the counterpart support part 14 and fixes it laterally in position. To permit a good load transfer, the wall element 29.1 rests on top of the counterpart support part 14.

As shown in FIGS. 2 and 3, between the reinforcing elements 16 and 28, there is sufficient open space so that all of the interior regions of the lower part 10 and upper part 20 communicate with one another in an air-conveying fashion.

A bellows 30 is shown in FIG. 2. For the sake of a clearer depiction, the bellows 30 is only shown on the left side of the plunger piston. The bellows 30 is arranged circumferentially in a known fashion. The bellows 30 has a fastening ring 31 that rests against the connecting edge 26 and is fastened to it. After its fastening ring 31, the bellows 30 is continuously deflected by the rounded transitions 23 and 25 of the upper part 20 and laterally guided along the side wall 22 and the casing part 11. The cylindrical region formed by the side wall 22 and the casing part 11 form a contact and rolling surface for the bellows 30. The cavity enclosed by the bellows 30 is spatially connected to the cavity of the hollow body composed of the upper part 20 and lower part 10. This spatial connection is produced by the air passage opening 27.1 in the region of the connecting edge 26.

1. A plunger piston for an air spring, the plunger piston being formed as a hollow body and having a bottom (12) to which a circumferential casing part (11) is indirectly or directly coupled, and the plunger piston in a cover region remote from the bottom (12) having a connecting edge (26) for a bellows (30) and at least one air passage opening, the hollow body having a cup-shaped lower part (10) comprising the bottom (12) and the casing part (11), an upper part (20) placed onto the lower part (10) and connecting to the lower part (10) in an airtight fashion, and the upper part (20) having the connecting edge (26).

2. The plunger piston as recited in claim 1, wherein the casing part (11) has a cylindrical region that transitions into a circumferential cylindrical side wall (22) of the upper part (20) having a same diameter.

3. The plunger piston as recited in claim 2, wherein the lower part (10) and upper part (20) each has a circumferential edge (15, 21) and the upper part (20) with the lower part (10) are joined to each other at the edges (15, 21) by a sealed connection.

4. The plunger piston as recited in claim 3, wherein the lower part (10) and/or the upper part (20) each is reinforced by reinforcing elements (16, 28).

5. The plunger piston as recited in claim 4, wherein the reinforcing elements (16) of the lower part (10) are formed as ribs integrally onto the casing part (11) and extend in a radial direction.

6. The plunger piston as recited in claim 5, wherein the reinforcing elements (28) of the upper part (20) are formed integrally onto the connecting edge (26) and protrude into an air passage region enclosed by the connecting edge and at least a part of the reinforcing elements (28) in a region remote from the connecting edge (26) are connected to a reinforcing part (29).

7. The plunger piston as recited in claim 6, wherein at least a part of the reinforcing elements (28) of the cover part (20) have a supporting part (29.2) supported against a counterpart supporting part (14) of the lower part (10).

8. The plunger piston as recited in claim 7, wherein the reinforcing elements (16 and 28) of the lower part (10) and the upper part (20) are at least partially supported against each other.

9. The plunger piston as recited in claim 8, wherein the cover-like upper part (20) encloses a partial cavity that combines with the partial cavity formed by the lower part (10) to form a whole cavity, and the partial cavities communicate with each other in an air-conveying fashion.

10. The plunger piston as recited in claim 9, wherein the lower part (10) and/or the upper part (20) each is embodied as an injection-molded plastic part.

11. The plunger piston as recited in claim 10, wherein the upper part (20) has a convex, rounded transition that supports a transition section (24) and adjoins the cylindrical circumferential side wall (22), the transition section (24) is sloped toward the lower part (10), and the annular connecting edge (26) adjoins the transition section (24) by a concave rounded transition (25).

12. The plunger piston as recited in claim 11, wherein the bottom (12) of the lower part (10) has a reinforcing element coupled to the bottom (12) or embedded into the bottom (12) during an injection molding process.

13. The plunger piston as recited in claim 12, wherein the reinforcing element is formed as a plate or a ring, with a plane of the plate or the ring oriented in a direction of a bottom plane.

14. The plunger piston as recited in claim 13, wherein the reinforcing element has a greater hardness than the bottom (12) and is of metal.

15. The plunger piston as recited in claim 1, wherein the lower part (10) and upper part (20) each has a circumferential edge (15, 21) and the upper part (20) with the lower part (10) are joined to each other at the edges (15, 21) by a sealed connection.

16. The plunger piston as recited in claim 1, wherein the lower part (10) and/or the upper part (20) each is reinforced by reinforcing elements (16, 28).

17. The plunger piston as recited in claim 16, wherein the reinforcing elements (16) of the lower part (10) are formed as ribs integrally onto the casing part (11) and extend in a radial direction.

18. The plunger piston as recited in claim 4, wherein the reinforcing elements (28) of the upper part (20) are formed integrally onto the connecting edge (26) and protrude into an air passage region enclosed by the connecting edge and at least a part of the reinforcing elements (28) in a region remote from the connecting edge (26) are connected to a reinforcing part (29).

19. The plunger piston as recited in claim 4, wherein at least a part of the reinforcing elements (28) of the cover part (20) have a supporting part (29.2) supported against a counterpart supporting part (14) of the lower part (10).

20. The plunger piston as recited in claim 4, wherein the reinforcing elements (16 and 28) of the lower part (10) and the upper part (20) are at least partially supported against each other.

21. The plunger piston as recited in claim 1, wherein the cover-like upper part (20) encloses a partial cavity that combines with the partial cavity formed by the lower part (10) to form a whole cavity, and the partial cavities communicate with each other in an air-conveying fashion.

22. The plunger piston as recited in claim 1, wherein the lower part (10) and/or the upper part (20) each is embodied as an injection-molded plastic part.

23. The plunger piston as recited in, claim 1, wherein the upper part (20) has a convex, rounded transition that supports a transition section (24) and adjoins a cylindrical circumferential side wall (22), the transition section (24) is sloped toward the lower part (10), and the annular connecting edge (26) adjoins the transition section (24) by a concave rounded transition (25).

24. The plunger piston as recited in claim 1, wherein the bottom (12) of the lower part (10) has a reinforcing element coupled to the bottom (12) or embedded into the bottom (12) during an injection molding process.

25. The plunger piston as recited in claim 24, wherein the reinforcing element is formed as a plate or a ring, with a plane of the plate or the ring oriented in a direction of a bottom plane.

26. The plunger piston as recited in claim 12, wherein the reinforcing element has a greater hardness than the bottom (12) and is of metal.
